(19) United States
(12) Patent Application Publication
(10) Pub. No.: US 2015/0363811 A1
(43) Pub. Date: Dec. 17, 2015

(54) SYSTEM FOR ADMINISTERING MULTIPLE INSTANCES OF GAMING AND DATA FROM A SINGLE ENGINE

(71) Applicant: John Candillier, London (GB)

(72) Inventor: John Candillier, London (GB)

(21) Appl. No.: 14/304,078

(22) Filed: Jun. 13, 2014

(51) Int. Cl. G06Q 30/02

(52) U.S. Cl. CPC G06Q 30/0217; G06Q 30/0236

(57) ABSTRACT

Disclosed herein are systems and methods for gaming a person's connections with a brand. By collecting data in response to targeted questions, a brand owner can quickly understand what the user knows and feels about his brand, both on factual and emotional. By awarding points for answering questions, the user can unlock areas of the system, allowing access to awards, such as vouchers, which can be redeemed for real world prizes.

### TECHNICAL FIELD

The present disclosure relates to systems and methods allowing for the digital gamification of e-commerce interactions between consumers and brands, whereby brands may collect, qualify and monetize readily-actionable information which consumers willingly share with them inside a private gaming experience, in return for exclusive incentives.

### BACKGROUND

It is widely understood in marketing that games have subliminal powers to convey certain promotional messages. Online games are played by more than 50% of young adults—defined as the 18-34 age group. It is believed that over 70% own a smartphone, 80% utilize social networks, and 60% look for discounts online. One of the issues for brands today is how to build early relationships with young adults, so that as they become mature consumers, those brands that have given them the best experiences become their brands of choice for life. This is key to securing long-term, loyal customers.

Yet, no conventional system today exists based on the idea of games as a permanent marketing and e-commerce tool, outside of traditional punctual product placements and prize draws.

Presently, there exist a number of systems for collecting data on people who are “fans” of a particular brand. These “fans” can be those who either have used or wish to use a particular product or service associated with the brand, or those that may be interested in more information about the product or service. According to those systems, a user may register as a fan of the brand (e.g., by indicating that he “likes” the brand) and thereafter can receive information relating to the brand. Although brands can have access to certain demographic information about users, e.g., age, sex, city/state/country and possibly other interests, they are in all cases prevented from interacting directly with their fans.

Unfortunately, such systems prohibit the brand owner from determining how much of a “fan” the user actually is. Specifically, once a user has indicated that he “likes” a brand, the information gathering relating to that user is complete. There is no other relevant information that can be gathered about this user and his interaction with the brand. In some instances, the indication that the user is a “fan” can be outdated, erroneous, or actually an accident or mistake negatively skewing any data analysis.

Conventional data collection systems also invite privacy concerns. For example, when a user utilizes many of the currently existing social networks which have data collection mechanisms, it is very difficult for the user to understand and curate the data that is collected, utilized and possibly sold. Therefore, users can be reluctant to interact and provide useful data. While many conventional systems attempt to describe their privacy policy, such is often presented in the form of a lengthy document, often resembling a complicated legal contract. As a result, users often do not even read such document and do not understand what is really happens with their data.

Finally, when the system is part of a social network, one could argue the brand owner merely “rents” his followers from the system, left at the mercy of those who set the price for reaching pools of acquired digital followers while retaining full control of how any data can be generated, maintained and/or utilized. In the extreme scenario whereby a brand owner decided that he was no longer interested in using that particular social network, he would immediately lose all access to his “fan base”. By definition, the latter is not proprietarily held.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present invention is a system for strategic gaming solutions for digital brands, allowing for social audiences to be qualified, fanatized and monetized. Such system, dubbed Branded Gaming Network, is replicated using a common gaming experience template for each brand, while being subjected to custom-made alterations to stay true to each brand's identity. The idea is to convert commoditized social followers into qualified, loyal buying customers loaded with incentives in return for learning about their favorite brands and give away relevant consumer information willingly. In exchange for winning prizes and exclusive offers directly from the brands, those fans tacitly agree to tell the latter what they know about it, think about it and may want to buy, down to the product level. This two-way exchange is then complemented by a data back office interface controlled by the brand, allowing it to generate personalized and targeted promotional product offers entirely linked to the data analysis provided within the same interface.

Through the invention, fans can opt-in for a new ‘gamified’ engagement channel through which they willingly expose themselves to reward-based branding initiatives and active promotional considerations. Halfway between a digital media tool and a social game, the present invention focuses on the concept of Branded Gaming Networks for brands looking for a digital life outside of conventional social networks. Such Branded Gaming Networks are best designed to be hosted under one digital umbrella, either in the form of a master website or host application in an app store and thereby creating a central place online for brands and fans to fully consummate their relationships, away from social networks.

The system is designed to reap the “halo” benefits of a brand's social audience via the viral nature of game playing. To deliver in practice, the system can use its own adaptations of the game of trivia as the ideal medium to create addictive and data-rich ecosystems designed for fans to have fun while learning facts and information selected by the brand owner.

Once social communities have been rounded up on conventional social networks, brands should start thinking how to take their followers to a more private place in order to grow a more intimate and rewarding relationship together. The invention is configured to exercise complete and permanent control over user engagement via storied content and readily monetized data.

Privacy concerns are also mitigated, as the invention can be open and clear about which data is being collected and used. Specifically, in order to determine how much a user knows about a brand or product, the system can ask. By presenting the user with clear, obvious and simple questions, the user can know exactly which type of information he is willingly providing to the system, as part of his user experience.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the present disclosure is not limited to the specific methods and instrumentalities disclosed. In the drawings:

FIG. 1 is a block diagram showing an example system in accordance with embodiments of the present invention.

FIG. 2 shows a block diagram depicting example user interaction with the system in accordance with the present invention.

FIGS. 3A and 3B show, in one embodiment, how brand owners can utilize the system.

FIG. 4 is a chart showing a registration process in accordance with the invention.

FIG. 5 shows an embodiment of how a user might log in to the system of the invention.

FIG. 6 is a flow diagramming one possible embodiment of how the game may proceed.

FIG. 7 shows how, in one embodiment, the system calculated the leaderboard for the games.

FIGS. 8A and 8B demonstrate how, according to the invention, the game status can be determined.

FIG. 9 indicates how, according to the invention, the winner of a particular game can be measured.

FIG. 10 is a flow chart explaining how the voucher system can work, from the user's perspective.

FIGS. 11-13 are flow charts depicting the back-end of the system of the invention not seen or directly interacted with by the user.

### DETAILED DESCRIPTION

The present disclosure is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described. It should be understood that the systems and components disclosed herein may be suitably implemented by hardware, software, firmware, or combinations thereof. For example, the systems and components may be implemented by one or more processors and memory.

As used throughout the present specification and claims, “connections” is used to mean any link through a digital social network between a particular person and a brand. This can be in the form of a “like,” a follow, a mention, check-in, tag or any other association between a user and the brand. These connections are platform agnostic and can be in whatever form the particular social network determines.

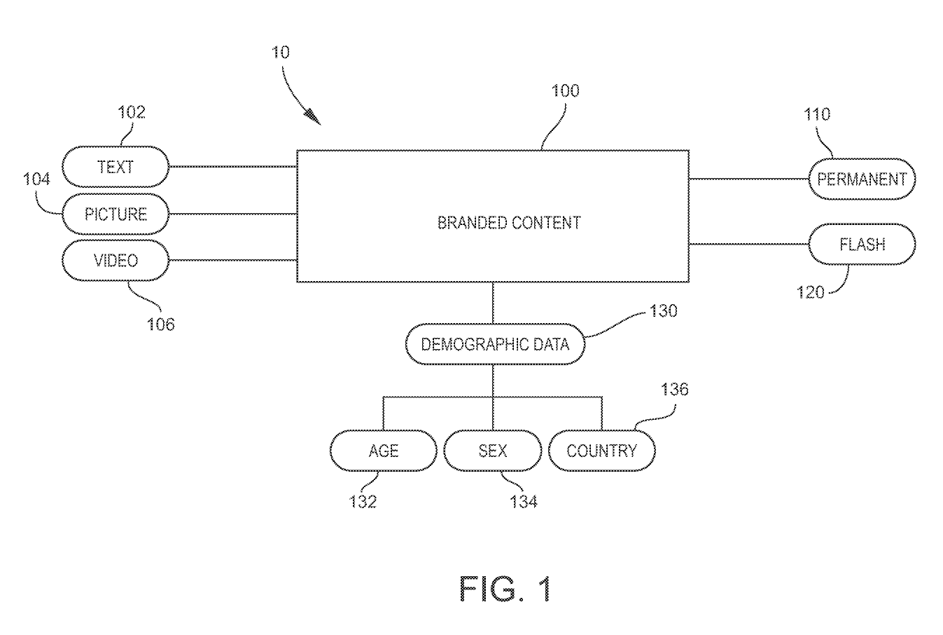

FIG. 1 illustrates a block diagram showing an example system in accordance with embodiments of the present invention. Referring to FIG. 1, the system 10 can operate to collect information from its users through pre-selected branded content 100. In a first step, a user or fan can provide basic demographic and other information, e.g., date of birth, gender, country of residence, marital status, number of social network friends, and email address. This information may be provided by the user via a suitable user interface. In some embodiments, a user interface may be provided to ask the fan to provide the system 10 with information such that the system 10 can access the social network accounts of the fan to, e.g., post to the social network(s) as the fan or directly invite friends of the fan to engage with the system 10.

Once the demographic information is collected, the brand connection and cognition assessment begins. In one embodiment, the user is presented with a series of questions designed to measure what the user knows about the brand and how connected he may be to that brand. These questions often include: (1) how often he shops at the brand's stores, or purchases certain products from the brand item, or uses the service(s) of the brand; and/or (2) which specific products/services the user may prefer over others.

With continued reference to FIG. 1, the gamified content or branded content 100 which is shown to a fan or user of the system can use a variety of media, such as text 102, picture 104 and/or video 106.

Such content can be designed to allow maximum flexibility in relation to who what, when and how. First, branded content can be either permanent 110 or temporary 120 (flash) with a set expiration date. This allows for the differentiation between timeless content (e.g., history, values, milestones) and current content (e.g., product launches, new collections, big news). The individual items or categories of branded content 100 can be sent to the entire population of fans or targeted towards certain demographic segments (e.g., male vs female, specific county or countries, specific age group(s)).

Any other type of content is simply called ‘general content’ and covers a wide range of globally popular topics such as music, films, people, TV, books, sports and general knowledge. The quality and maintenance of general content is relevant to retain users and, as such, it is constantly updated to stay relevant and current. Much of it is also designed for local audiences only.

The branded content 100 may be particularly relevant to extract brand awareness and emotional data regarding the brand, and the branded content 100 is often divided into two distinct categories with factual questions (relating to brand awareness) and soft questions (relating to emotional information). In accordance with embodiments, the content can be provided as a quiz, survey or questionnaire, where the user is given a question. The answer is most often in multiple choice format, which allows for simple and scalable data analysis.

Typical factual content can include (1) information relating to descriptions of branded products or, more generally, product ranges; (2) information relating to history and people (milestone dates and achievements of the products/services, and data on the founders and management of the company); and/or (3) a “fact file” (often providing information such as anecdotal facts and figures about the company, its products/services, and values). The soft content often relates to (1) purchasing intentions (for major holidays or birthdays for family, friends or the user himself), (2) purchase preferences (preferred product and/or range, or preferred usage/color); and/or (3) opinion and thoughts (information relating to the product/service itself—price, look, size, convenience, and requirements, or questions relating to characteristics of future products).

Most often, while the soft content requires a personal answer, the factual content requires a correct answer and both are rewarded equally within the system. However, because the factual data requires “correct” answers, questions with incorrect answers can be easily determined and tagged as fans with lower brand awareness. Specifically, the inclusion of the factual content questions alongside the soft content provides perspective about what fans think about a specific brand versus what they actually know about the same brand. As such, any statistical discrepancies could easily be identified via either more targeted branded content and/or commercial action. For responding to the game questions, users can receive rewards as points and virtual badges, the latter being used to access exclusive offers directly uploaded by brand owners.

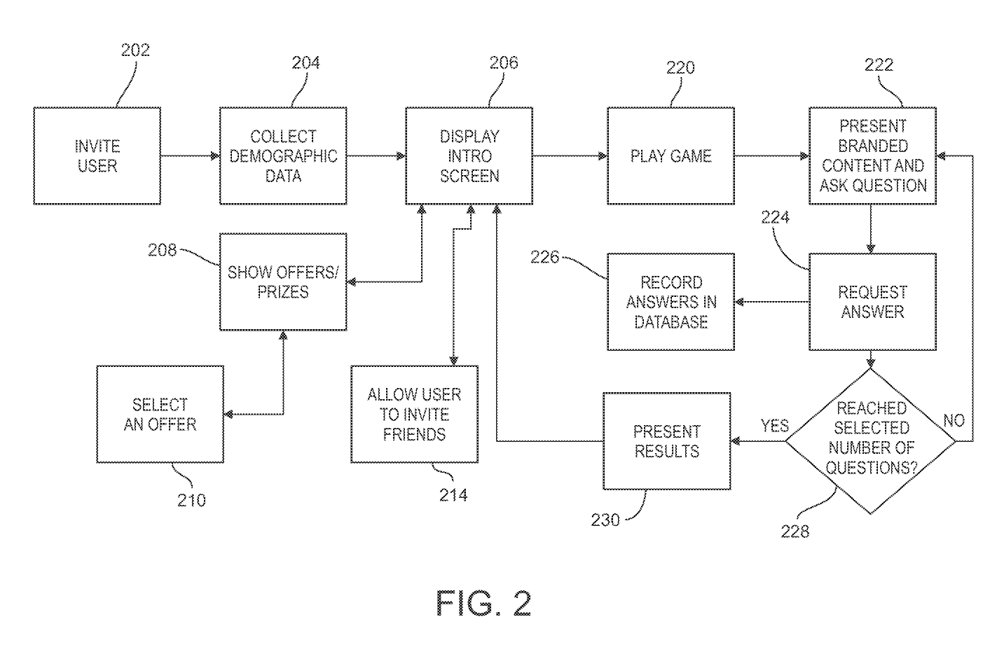

FIG. 2 shows a block diagram depicting example user interaction with the system in accordance with the present invention. It is noted that the example of FIG. 2 may be implemented by, for example, the system shown in FIG. 1, or any other suitable system. Referring to FIG. 2, a user is initially invited to participate (Step 202). The invitation can be made by following a link in an email or a post on a social network. It is also considered within the scope of the invention to provide a link or URL printed directly on a receipt, either a register receipt from a traditional brick and mortar retailer or connected to an online receipt, shipping notice or other communication from an online retailer. The recipients can also be selected from among “fans” on traditional social networks, and by analyzing a customer's purchase history from an online retailer. In an embodiment, the recipients are selected as those that are more likely to have a connection with the particular brand or may otherwise wish to participate in the game and reward system. However, the invitations can simply be sent out to known emails (i.e., those that do not appear to have any existing connection to the brand), in an attempt to find users.

The user may then input his demographic information (Step 204). This information often includes name, address, telephone number, and age, but can also include other items including, but not limited to, education level, income level, number and age of children, occupation, number and types of cars, rent/own home, or any other type of information that the brand owner might find useful. Additionally, one or more of the fields can be made mandatory while others are optional. This gives the user the ability to select which information he prefers not to reveal, while still being permitted to participate. The user may be incentivized to answer the more personal questions and provide more detailed information by being rewarded with extra badges (as hereinafter described). In one embodiment, the user is reminded that he is providing this information at his own election, and only the information he or she expressly provides to the system will be given to and used by the brand owner, thus providing the user with a degree of privacy and comfort in the system.

After collecting the demographic data, in Step 206, the user may be presented with the introduction screen. Here, the user is typically given a summary of the badges he has earned, a general description of certain offers of vouchers that may be available to him, as well as an option to play the game of the system to earn more points and/or badges. Based on the data known about the user, the system may use the introduction screen to suggest to the user that he participates in other branded gaming networks in accordance with the invention.

One selection can bring the user to a screen providing details of the various offers and prizes (Step 208). Here, the user may be given details about the specific items he can currently redeem and items he may not yet be eligible to redeem. In one embodiment, the items and their “redeemability” are based on the number of badges the user has earned through the system, as well as the selection criteria by the brand owner (as will be described). The items are often displayed as a voucher, which can be activated by the user for a particular number of badges. These items can be physical items, e.g., electronic products, clothing, sneakers, or any other physical product that can be shipped or mailed to the user, or digital items, e.g., credits for online stores, or downloadable content. The vouchers can be for discounts on the items or can be the total payment for the item. In one embodiment, the items are common items that can be purchased online or in stores, but in some embodiments, the items can be unique items that cannot be otherwise purchased (such as autographed items or other memorabilia). In Step 210, the user may be provided the option to select one of the offers, and thereafter, the appropriate number of badges is deducted from his account and the reward is provided.

It is considered within the scope of the invention to provide an alert or other type of notification to other users when offers are redeemed. For example, other fans of the brand can be notified (SMS, email, application notification) after a predetermined number of offers have been redeemed. Such a notification might read, “Twenty-five fans of Brand X have redeemed a voucher for a free t-shirt. Click here to find out more.” This notification can be sent to others that have been determined to be eligible, other fans of the brand or even those who are not fans of the brand. These notifications can also be automatically posted on the user's social networks each time he redeems an offer. Such steps can help to advertise the system.

The user can also select the option to invite his friends to participate (Step 214). As described herein, the user can be provided with a link or a code so that the system acknowledges that this particular user referred the new users. This can also be accomplished by having the user provide access to his friends list from his social networks or even the contact list from his email.

If the user elects to play the game from the introduction screen (Step 220), he is presented with branded content and asked a question about that content (Step 222). This content, is typically as is described in connection with FIG. 1. Once the user answers the question (224), the response is recorded in the database (226) to be analyzed and used later. This question and answer is repeated until the predetermined number of questions has been asked (Step 228). The number is not limited, but is typically between 2 and 20, more typically between 5 and 10. Finally, the results of the game are displayed (Step 230) and the user is brought back to the home screen. The displaying of the results can, most often, inform the user of the number of questions answered correctly and the number of points and/or badges earned during the most recent game. It can also include the total number of games played and/or the number of total badges earned over different time periods, e.g., last week, month, year, etc. The same information can also be presented on the intro screen.

In one embodiment, the user wins one type of pointed for playing games and answering questions. Only when the user has earned enough points is he eligible to access certain parts of the system where he can earn badges. Thus, although points and badges are both awarded for participating in the system and answering questions, only badges are used to redeem vouchers.

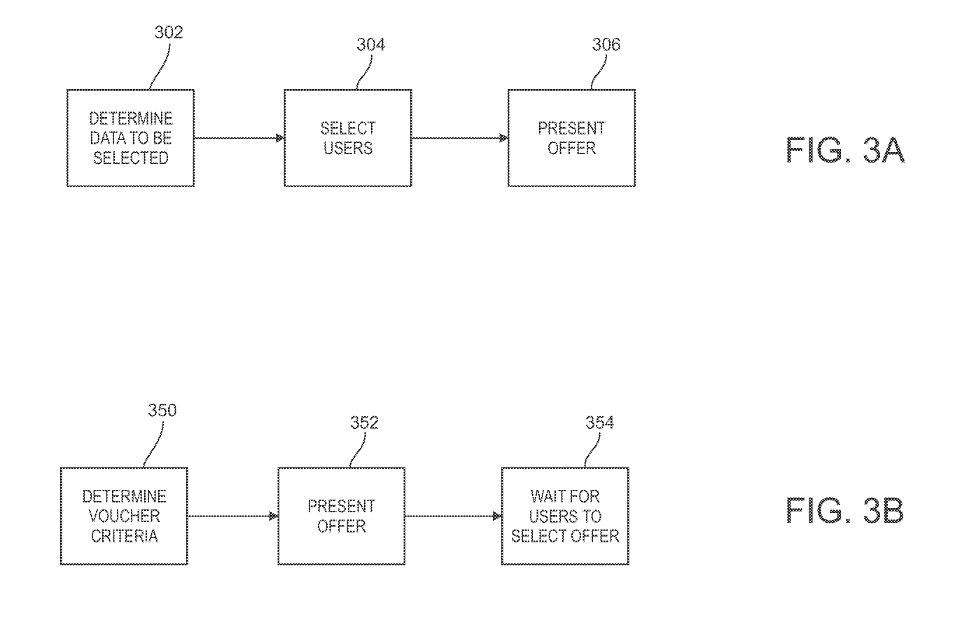

FIG. 3A shows a typical procedure for brand owners to present offers to fans. It is noted that the example of FIG. 3A may be implemented by, for example, the system shown in FIG. 1, or any other suitable system. In step 302 of FIG. 3A, the brand owner determines the particular data to be selected. This often includes the necessary number of badges and can be demographic (such as age, sex and/or income level) and/or data collected through the game (such as brand awareness, likelihood of purchasing product/service and/or some measurement of emotional connection with the brand). The system then searches through the database of users to identify those that meet the data criteria (Step 304) and the particular offer is then presented to the users (Step 306). These offers can be presented just as any other information of the system can be presented, e.g., email, SMS, notification and/or during access of the system.

FIG. 3B shows a procedure for offers that users are not currently eligible for. It is noted that the example of FIG. 3B may be implemented by, for example, the system shown in FIG. 1, or any other suitable system. In Step 350 of FIG. 3B, the eligibility criteria are determined (much in the same way as in Step 302), and the offer is presented to the users (Step 352)—again much in the same way as in Step 306. In this embodiment, the identified users are those that have not earned the correct number of badges, but are otherwise eligible to redeem the offer (e.g., have earned enough points to gain access to the offer, but do not have enough badges to redeem the offer). The user will be incentivized to interact with the system in order to earn those extra badges to become qualified to redeem the offer (Step 354).

By collecting information relating to (1) brand intelligence and (2) product intelligence, brand owners accumulate a wide base of information. Brand intelligence gives information relating to the social value, the awareness level and the brand inclination of certain demographic groups of users. Each factor can be assigned a separate “score” calculated according to a series of back-end assumptions. The product intelligence part of the invention allows for the collection of data, specifically, on a product or product category, ranging from awareness level to emotional connection connections and buying intentions. Moreover, all brand and product intelligence coming from both factual and soft branded content, can be tagged and cross-referenced against a series of variable demographic data, such as age, sex, language, nationality and possibly income level, using a multiple filtering system. All this information can then be collated into easy-to-read scorecards, allowing for commercially-minded consumer data analysis.

Once fans with a particular level of connection with the brand are identified, this particular user group can then become subjected to targeted commercial actions. In one embodiment, fans with “high” levels of product awareness and emotional connection, but only average buy intentions are easily identified and could be presented with targeted, special offers to increase their buy intentions. These special offers can be in the form of vouchers to purchase exclusive products only available through the system, such as collectables or limited run products, discounts for widely-available products or other custom or seasonal marketing initiatives linked to holidays or birthdays. Each offer contains a required number of badges for interested users to “spend” in order to obtain the unique activation voucher code.

The system of the present invention also allows for the accurate counting of advertisements, or branded content items, seen by fans. Rather than counting the number of “impressions”, the present system accurately determines the number of times that an item of branded content, either factual or soft, is presented to a fan. In conventional online advertising systems, an advertisement is displayed to a user, often in the form of a banner ad, or in a side bar or other portion of the screen which is often ignored. Unfortunately, such systems cannot differentiate between these “throw away impressions” and ones that the user might actually see and mentally engage with. Rather than being the annoying and often distracting unwanted information that gets in the way of the desired content, the branded content ‘advertisements’ of the present invention become the desired content. Through the games of the invention, every “impression” is directly displayed to the user and awaits his interaction in the form of a question to earn valuable points used in the game. The outcome of such interaction (right or wrong or personal answer) is tracked and recorded in the invention's back-end data engine, meaning the impact of each “impression” can be directly measured and qualified, either individually or as part of a wider, more statistically-relevant group.

The system of the present invention also allows for the rewarding of particular fans with exclusive, personalized offers generally not readily-available to non-users of the branded gaming network. This can be in the form of a voucher, discount or other valuable item. In one embodiment, a brand owner would use the data interface to identify and segment specific demographic consumer groups showing a statistical affinity to a certain product or product range. Once it has been concluded that the matching of both presents an attractive commercial opportunity, the system allows the brand owner to create a custom product voucher targeting the subset of consumers showing a statistical bias for buying such product.

One of the key components of a voucher is how consumers interact with it using the badges they earn while playing the game. Badges act as the currency giving access to vouchers which vary in terms of their exclusiveness. In other words, a brand owner may decide whether a voucher is for general distribution or limited distribution, and/or how many badges would a user need in order to activate it and receive a unique voucher code. The more badges required to activate a voucher, the more restricted and exclusive its access regardless of actual distribution sample size. Limited distribution vouchers are by definition more exclusive and would usually carry a higher number of required badges for activation (there can be any number of badge requirements to choose from: typical badge requirements are 0, 25, 50, and 100, as well as any number in between). Depending on the exercise, limited vs. general distribution, brand owners can choose to upload a single-code voucher (one code to share amongst the entire target distribution sample) or a multi-code voucher (defined by a CSV file of unique codes used for single activation).

It is also considered within the scope of the invention to have the badge requirements be variable. In such an embodiment, the number of required badges can increase as vouchers are redeemed. For example, the first user to redeem a voucher might only need 50 badges, but the second user might need 55 badges. The number of badges can increase linearly, e.g., 1-5 badges at a time, based on the number of vouchers redeemed, or the number of required badges can increase simply as a matter of time, where, for example, the required number will increase every 24 hours.

Depending upon the number of vouchers redeemed, the system can offer the same vouchers to different numbers of fans. For example, when first offered the voucher can be made available to only those fans that have a high awareness level coupled with a low brand inclination, and after one day, the offer can be expanded to those fans with a higher brand inclination. This can be automatic, based on certain predetermined criteria, or manually, as determined by the brand owner. Such a system allows for extremely customizable commercial interactions with users.

In one embodiment, the vouchers are designed to be uploaded into the game directly from the brands owners to those users included in the target distribution sample. The vouchers usually contain a promotional code directly from the affiliated brand partner which can only be accessed once a user decided to ‘spend’ the required amount of badges. This promotional code can be expressed as a percentage discount which either applies across the brand or only on selected item(s). The badge spend requirement not only drives exclusiveness but also aims to reward the most loyal players/fans by giving them access to personalized offers few others could activate due to his or her lack of badges. In most embodiments, this functionality occurs in a single secure interface location, where the content is uploaded, stored, presented to users, and where badges are earned and subsequently redeemed for vouchers.

The present system provides for user privacy not found in conventional systems. As described above, users are presented with a variety of questions, some of which relate to personal information, such as, age and nationality. As the user interacts with the system, the user will provide personal data which may necessarily be collected and analyzed. However, the system is upfront with users in terms of which data is collected and no “privacy settings” are required. In other words, the only information that is collected is the information that the user directly provides to the system, while enjoying a gaming experience and trying to win prizes and loyalty points. If a user wishes not to provide the answer to a particular question or provide that type of information, the system can be configured to accept this “blank” response and proceed accordingly, but generally, users are provided with incentives to answer the questions. In many embodiments, users are reminded that the responses are made available to the brand owners, but kept confidential from other users. Such a privacy policy is very simple to explain, understand and implement.

Through the present system, the brand owner is provided with a large amount of data which can be acted upon very quickly. Once a match is established between a user and a particular brand, the brand owner is only a few clicks away from sending an exclusive, personalized offer to the interested consumer group. Vouchers can be uploaded into the system for users to activate with their earned badges.

In one embodiment, the system can be particularly designed and customized to accommodate a single brand or a number of sub-brands all owned and managed by a single brand owner. As such, all branded content within a singular branded gaming network is solely devoted to one brand, or a family of brands, in order to recreate and ensure an exclusive shared experience between the latter and its fans/users/consumers.

However on a different level, the invention may become an aggregator, whereby the system can act as a single digital hosting entity for multiple, yet distinct, branded gaming networks for affiliated brand partners. The system's centralized administration interface allows for the creation and management of a single gaming and data template across multiple brands and languages (if relevant), while retaining complete flexibility on the customization requirements from one brand partner to another. While being originated from one common template, each brand partner retains the ability to fully customize both its own game interface (look, feel, content, user experience etc.) and its own data engine (type of data, quantity of data, scoring methodology, product tracking etc.). However, the backbone architecture of the offering stays the same across all brand partners, not only allowing for scalable origination and management of the platform but also quick adoption both from users and brands who may easily associate with a white-label approach aiming to become a benchmark solution.

The system of the present invention can also be integrated into currently existing online platforms. This is particularly useful to drive user traffic to the system. For example, if a particular existing system or App Store is used to sell/rent movies, magazines, music and applications (often referred to as “apps”) to be used on mobile devices, such an App Store already knows a particular user's habits and likes, particularly if the App Sore includes a rating system (which can be based on a 1-5 star system). Because the App Store already knows a user's preferences, the system of the invention can suggest that the user access the system of the invention and particularly access the parts of the system relating to brands similar to the user's preferences. For example, if a user subscribes to magazines related to running, has installed applications which map out runs or track exercise or count calories, and has searched for websites and information about similar subject matter, the App Store can present to the user the part of the system relating to companies marketing or selling running shoes, exercise clothing or equipment. Because of the connection between the information already known about a user from his use of the App Store, it is more likely that a user would be interested in participating in a branded gaming experience which has close affinity with his interest.

In one embodiment, in addition to apps (including games), magazines/newspapers, books, movies/TV and music, the App Store may include a section particularly devoted to Brands. Each different brand that is part of the system can be a separate tab or section within the Brands section of the App Store. In another embodiment, the Brands functionality can be embodied in a separate application downloadable from the App Store.

For example, many App Stores already include an aggregated game center, where scores, achievements and game play history are stored and shared. The system of the invention may service a similar aggregating role such as a game center, which a user would visit or opt to play a game about a particular brand for which he may have a certain interest for or affinity with. This aggregating host function could therefore be known to both consumers and brands as the digital meeting place of choice, where in return for entertainment value and incentives imbedded within a familiar gaming template, users willingly choose to reveal much about their consumer habits, specifically vis-à-vis those brands.

In another embodiment, such a digital aggregator works as a standalone community of digital fans and brands, able to notify all community members, regardless of brand affinity, about winners, prizes and live vouchers available across all brand partners. In a way, once in its mature format, such a digital aggregator of individual Branded Gaming Networks may drive cross-brand acquisition behaviors whereby a fan of Brand X decides to become a fan of Brand Y, attracted to the latter because of the centralized notification and reporting system for winners, prizes and live vouchers. From the perspective of the brand owner, having its own Branded Gaming Network featured and reviewed into the aggregating home becomes a self-fulfilling alternative to existing “fan” and “like” based systems, not only because it facilitates the export of entire segments of ‘real’ digital fan onto a platform which they can quantify and monetize repeatedly, but also because of the polarization effect of being alongside other mega consumer brands and the ability it brings to grow one's fan base further.

It is considered within the scope of the invention to enable the system to post to the user's other social networks, in addition to any other post/notification which may occur within the walls of an aggregator application. For example, just as a game center functionality tells the user's game center friends of his activity, the system can be configured to post the same types of information to the user's Facebook, twitter, Instagram or any other social network. In order to encourage users to permit posting of this type of information, a user can be provided with certain benefits such as more points or badges. That way, the user is “compensated” for the use of his information. Again, the privacy concerns can be mitigated as the user is told up front and is directly rewarded for the use of his information.

The system can also be configured to provide the user with badges if his friend begins using the system. This can occur by posting a referral link to which can be delivered directly to the user's friends through public social networks or email. In order to encourage additional participation, the system can also be configured to provide the friend with points and/or badges once he signs up as well. This way, both the user and the friend are rewarded when a friend begins using the system. Moreover, once a friend is correctly registered, the system can reward the referring friend by rewarding him with a set number of badges per successful referral. It is expected that such initiative may help increase the user base significantly.

Additionally, a user can be presented with a notification that he is eligible to redeem a voucher. This can be the result of an automatic search through a database of users to identify users with specific characteristics and/or a manual selection by a brand owner, or even sent to every person registered with the system for a particular brand. The notification can alert the user that only a specific number of vouchers are available or that there is a particular time window for redeeming the voucher or that he needs a certain number of badges in order to redeem the voucher.

These types of notifications are commonly used in mobile devices (e.g., phones and tablets), where the information or an icon is displayed upon receipt of the notification, or only displayed when the application is opened. These notifications can also be configured to pop-up or otherwise remind the user each time he accesses the system.

The system of the invention additionally includes a data interface, giving the brand owner access to the collected data and branded content. This part of the system can include many different methods for analyzing and viewing the collected data. Each data element that is collected, e.g., demographic, game results, vouchers offers and/or accepted is capable of being accessed and analyzed through the data center. In one embodiment, the data can be sorted and displayed according to any field. For example, if a brand owner wants to see how often certain vouchers were redeemed by country or based on education level, the data can be so displayed. By providing the brand owner with this degree of granularity, the collected data can be used to provide a great deal about how fans are relating and reacting to a brand. By comparing changes in that data, the brand owner can determine how different actions, e.g., offers within the system, or even external advertising and brand exposure, are impacting fan sentiment towards the brand.

The system of the invention can also be configured to output the database into other formats. In its simplest format, the data can be output in a spreadsheet format (e.g., CSV) so that it can be manipulated and studied via standard commercial spreadsheet applications. In other embodiments, the data can be imported into a mapping service so that the data can be shown graphically on a map. The system also has the flexibility of being conducted in a variety of languages, where the data is collected in a single language. In other words, despite the language of the user interface, the data can be collected and stored in a single language.

Because the user of the invention actually selects the branded content, the latter is much more likely to have an impact on the user. Initially, only users with an interest in the particular brand will engage with the system. Additionally, the answers to the questions are analyzed to present more targeted and focused content to the user. For example, if the brand is a sneaker company, different questions can be asked to determine which activities the user participates in while wearing the brand's sneakers. The answers can be used to present the user with information relating specifically to those activities or to closely related activities to expand the user's knowledge of the brand. As a result, the particular content being delivered to the user is determined by the user's responses, making the content more relevant to the user and much more likely to make a lasting impression.

As discussed above, the system can also be configured to allow for certain areas to be unlocked once a user has earned a predetermined number of points. For example, the first area of the system that is open to the user is the training mode, where games are all of a branded nature. Upon earning enough points in such training mode, the user can enter the “bronze”, “silver”, “gold”, etc., levels. These metallic levels often correspond to prize events, as compared to the training mode which does not carry real prizes. In the prize events, the user can earn badges as discussed herein. The different levels can also have different types of offers/vouchers, where the higher levels are more desirable or valuable. For example, in the lower levels, the user may only earn vouchers for percentage off purchases, but at the higher levels, unique items (such as collectables, autographed or numbered items) can be earned. By having the stepped structure, users may be motivated to try to reach the next level for better or more valuable vouchers. Different number of badges can also apply to different levels. For example, once the user reaches the second level, a multiplier can be implemented for increasing the number of badges earned by answering questions, and the multiplier may increase each time the user reaches a subsequent level. In one embodiment, the level is determined by the number of vouchers, and as a user spends his badges on vouchers, his level can change accordingly. In other embodiments, once a level is achieved that level is maintained, irrespective of the number of badges held by the user.

The different levels can also unlock other features of the system. For example, a lower level may only have branded content relating to the items covered by the brand, but higher levels may contain branded content that provides information relating to celebrities or more interesting factual content less directly related to the brand itself. Moreover, the system can be configured with a social component, whereby a special social event, along with its own prizes, can only be unlocked by, e.g., inviting a minimum number of friends from the user's social network(s).

In order to increase how often users play the game of the system, awards can be given for subsequent play. In one embodiment, a user can earn a predetermined set number of badges for each subsequent time period (e.g., day, week, month) that he plays, or a multiplier can be used to increase the number of badges earned in the subsequent time period and can increase for each subsequent time period. The extra badges (or multipliers) can continue indefinitely, or be reset periodically. The extra badges can be awarded for merely accessing the system during the specified time period, for actually playing the game or only for answering at least a predetermined number of questions. In one embodiment, the additional badges that can be earned are predetermined, but in others, the number is variable, such that only by accessing the system can the user learn what the number is. In order to make sure that the user remembers about the additional badges being awarded, the system can notify the user, either by email, SMS or through a notification (such as through the application on a mobile device). The notification can be alerting the user that the badge bonus exists, is about to expire and/or has expired.

The system of the invention can also be used for cross-fertilization of brands, where the tendencies of users can be used to suggest that they interact with brands related to brands of which they are fans. For example, if a user is a fan of a high-end watch brand and has a salary in a particular range, he may also be interested in other designer fashion items, such as shoes or suits. The particular criteria and suggested related brands can be manually selected or determined based on correlations, where the user is compared to other users of the system and where there is a certain degree of correlation, the related brand is suggested. The actual suggestion can be made in any form, e.g., email, SMS, notification, etc. Additionally, a user can be given additional badges, for the existing brand and/or the suggested brand, to encourage participation in the system of the related brand. By analyzing data across brands, brand owners have access to a large amount of data not previously available.

The gaming network of the invention can also incorporate real-world components, such as tasks or questions for which badges can be earned. For example, tasks may include scanning a code (such as a QR code) from a particular product or magazine advertisement, or answering a question about an image from a billboard product packaging or instructional materials. This “scavenger hunt” can result in users thinking about the gaming system more than when engaging with the electronic part of the system. Moreover, the presence of “off-line” components can be used to encourage fans to become users of the system.

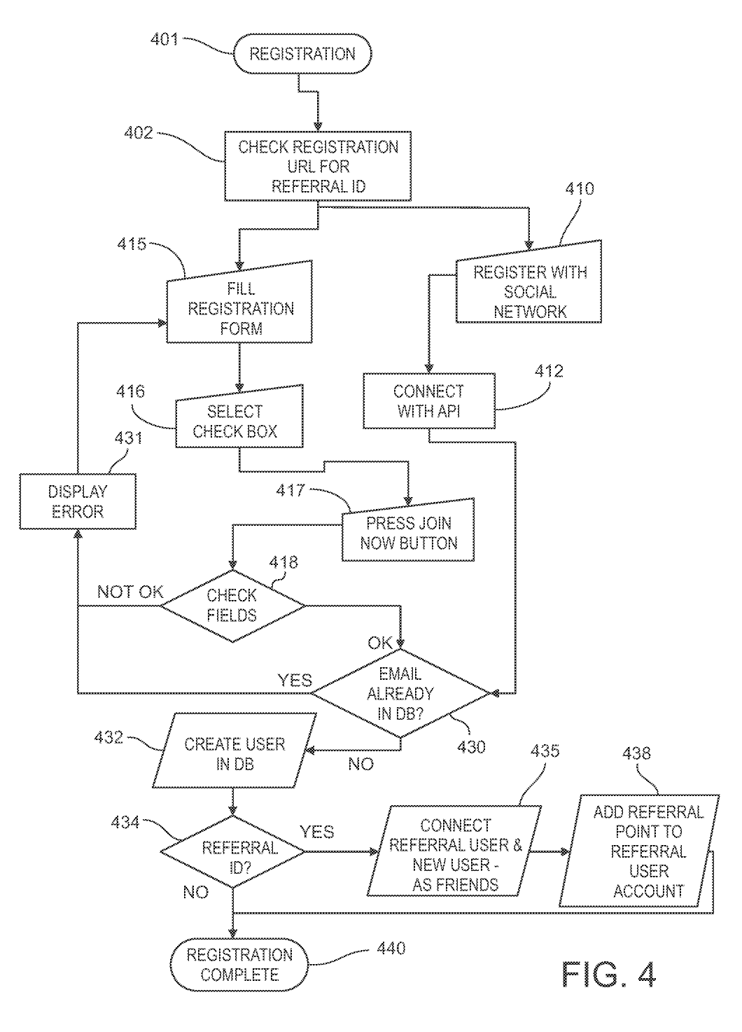

FIG. 4 shows, according to one method of the invention, how a user can register with the system. It is noted that the example of FIG. 4 may be implemented by, for example, the system shown in FIG. 1, or any other suitable system. In Step 401 of FIG. 4, the user begins the registration process by selecting a user name and password. The system then checks the URL used to access the system for a referral ID (Step 402), in order to reward a referring user with additional benefits for a successful referral. From there the user can elect to register using his information from a social network (Step 410), where his registration information is collected from the API of the social network (Step 412), eliminating the need for the user to manually enter the information. If however, the user elects to enter the information manually, he will need to fill out the registration form (Step 415) and select the check box to continue (Step 416). After the user selects a Join Now button (Step 417), the information is checked for completeness (Step 418) and to see if the user's email is already in the database (Step 430). If the email is already in the system or the form was not filled out correctly, an error is displayed (Step 431) and the user is returned to Step 415 to re-enter the information. Once correct and verified, a record is created in the database for that user (Step 432) and the user is asked to input a referral ID (Step 434), indicating that he was referred by another user. If a correct referral code is entered, the system matches the referring user and the new user and identifies them as “friends” (Step 435), and provides the referring user with a referral reward (Step 438). The registration is now complete (Step 440).

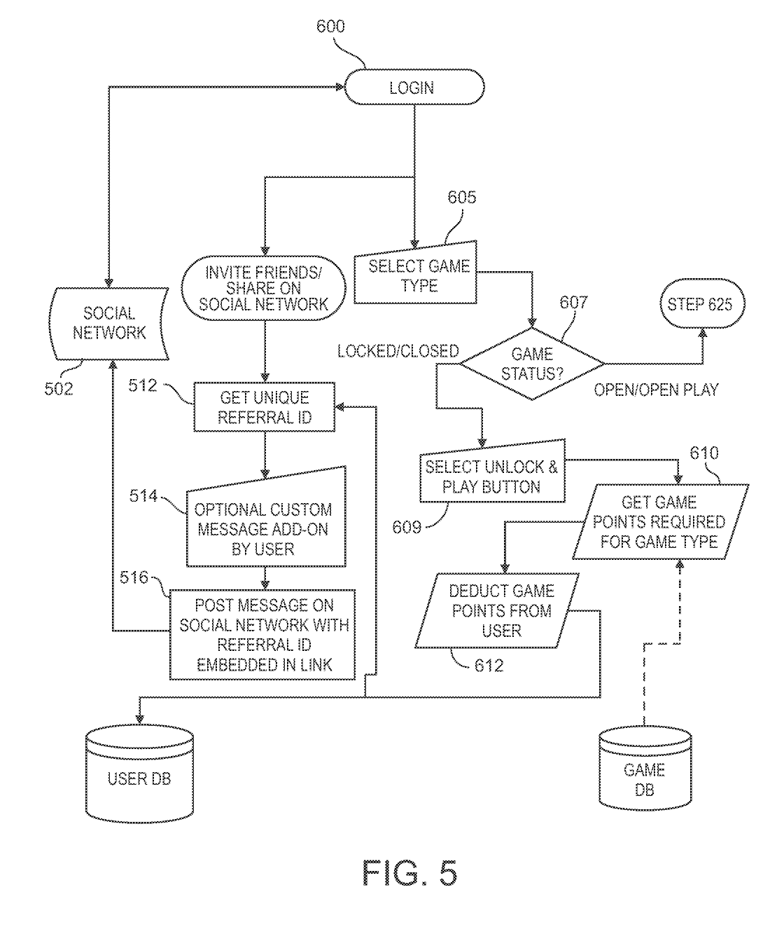

Should the user elect in Step 402 to register via a social network, after Step 412, the system interacts with the specific social network, beginning with Step 502 shown in FIG. 5. Additionally, the social network is accessed after each of Steps 435 and 438 to correctly identify the users. In Step 510, the system accesses the user database to obtain a unique referral ID (Step 512), allowing for a custom message to be sent by the user (Step 514). The referral ID and the message (custom or standard) are then posted on the social network with a link (Step 516) to be used by the user's friends on that particular social network.

At Step 600, the user logs into the system in order to access the games. This can be either directly through the system or through the social network. Thereafter, the user may select a game type (Step 605), and the game status is determined (Step 607). The game type can either be the training mode or a prize event. If the selected game is Locked or Closed, the user is given the option to unlock the game (Step 609) by determining the number of points required to play the game (Step 610) and having those points deducted from his account (Step 612).

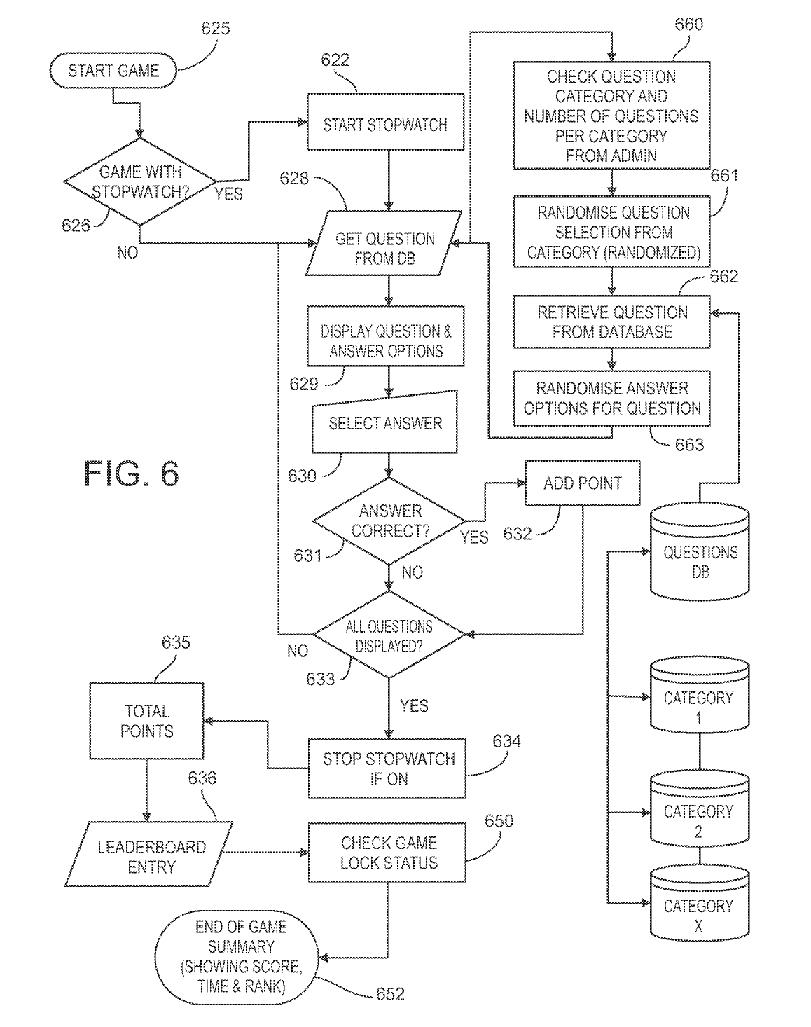

If, however, the selected game is already open, the system moves to Step 625 to start the game (See, FIG. 6). If the particular game has a time limit or otherwise involves timing the answers of the user (Step 626), the stopwatch is started (Step 627). Either way, the questions are obtained from the game database (Step 628). The game proceeds by displaying a question and answer options (Step 629) and allowing the user to select an answer (Step 630). The answer is compared to the correct answer (Step 631), and if correct, the user is awarded a set number of points (Step 632). If all questions have not yet been displayed (Step 633), the system returns to Step 628 to get an additional question from the game database, and the game continues. The stopwatch is stopped, if used (Step 634), and the number of points is totaled (Step 635). In Step 636, the system begins to determine if the score belongs on the leaderboard, either top 100 score (Step 640) with an associated time (Step 642). If within the top 100 score, the actual rank is inserted (Step 644), otherwise the score is identified as being “above 100” (Step 646). The score rank is then input into the leaderboard database (Step 648).

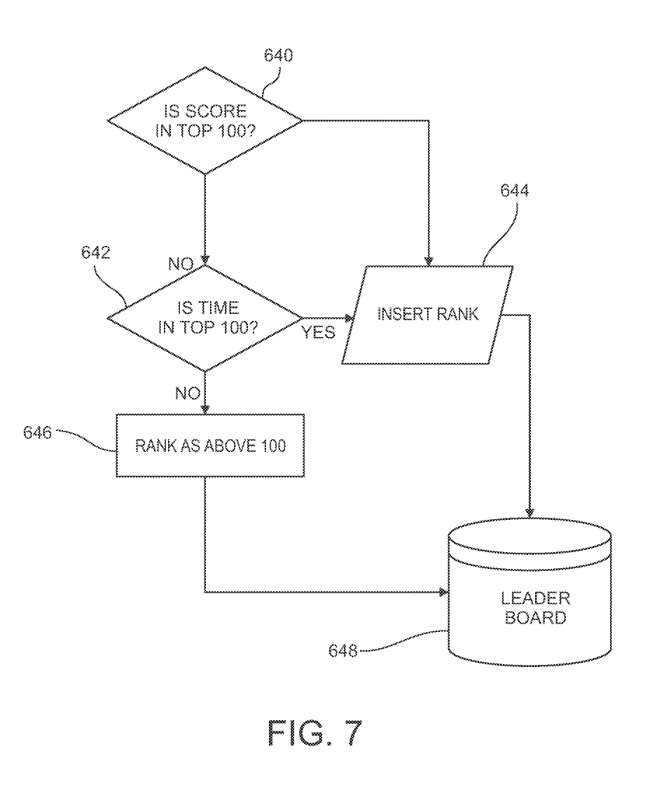

After the leaderboard determination, one embodiment shown in FIG. 7, the system checks the game lock status (Step 650). In one embodiment, the game lock status can be the maximum number of games allowed to be played by a single user during a particular time period—day, week, or game cycle. A locked status may also be in effect to prevent a single user winning the same game a second time during a specified period of time. Thereafter, the system displays the End of Game Summary, e.g., score, rank and time (Step 652).

In obtaining the question in Step 628, the system polls the question database. This occurs by first checking the question category and number of questions as set by the administrator (Step 660). Often the question is randomized (Step 661), it is then retrieved from the database (Step 662). The format via which answers are shown to players is also subject to randomization (Step 663).

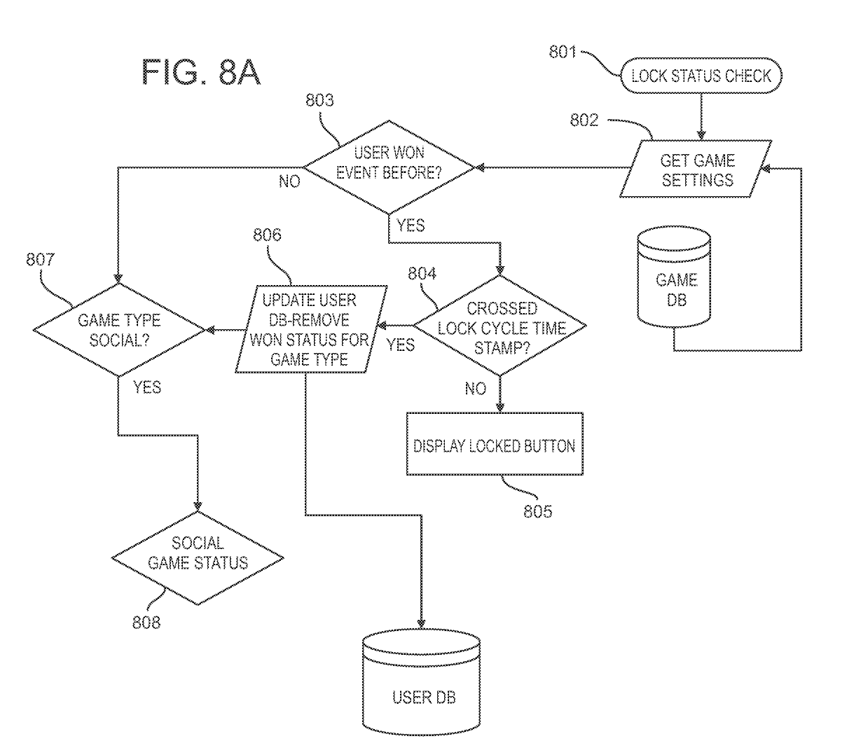

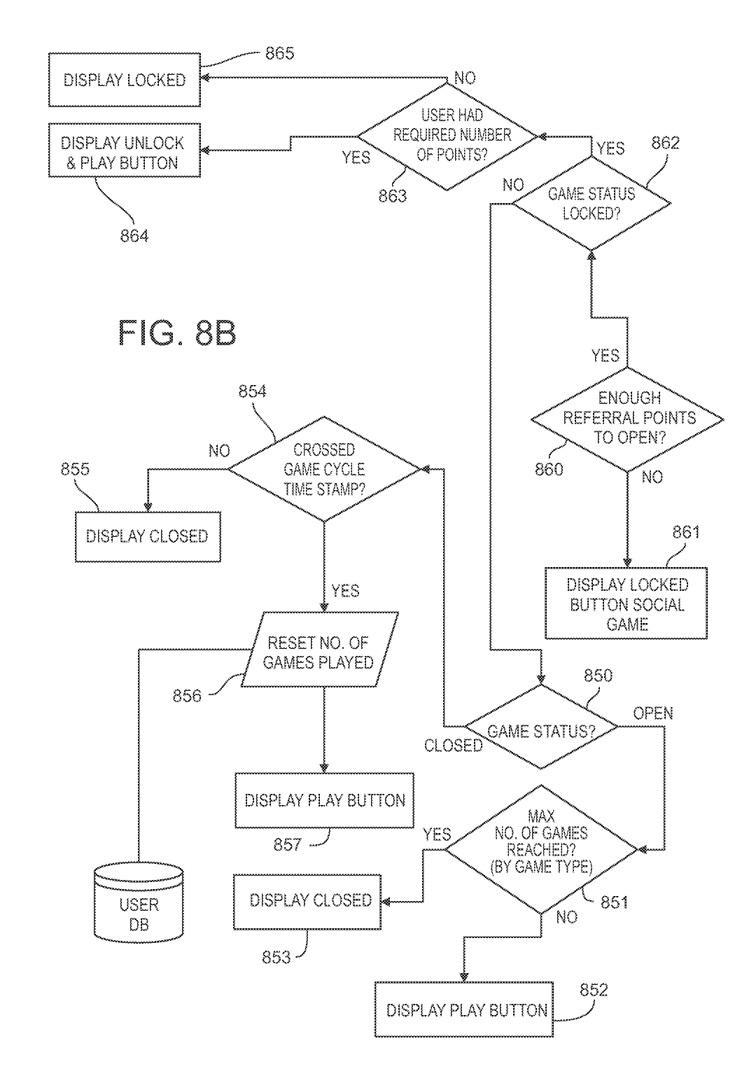

After selecting the game type in Step 605, the system can be configured to perform a lock status check (Step 801), as depicted in FIGS. 8A and 8B. This procedure includes getting the game settings (Step 802), relating to the game lock status, from the game database, and determining if the user has ever won the event before (Step 803). If so, the system determines if there is a crossed lock cycle time stamp (Step 804), i.e., a time period relating to the game status. If yes, a Locked button is displayed (Step 805). Otherwise, the system moves to Step 806, where the user database is updated to remove the “won” status for the particular game type. From Step 806 (and if the user has never won this event before—Step 803), the system determines if the game type has a social component (Step 807), and if so, to determine if the social game status is open (Step 808). If open, and the game status is open (Step 850), the system determines if the maximum number of games (by game type) is reached (Step 851). If the maximum number is not reached, a Play button is shown (Step 852). Otherwise, the display is closed (Step 853). If the game status, from Step 850, is closed, and the game cycle time stamp is not crossed (Step 854), the display is closed (Step 855). If, however, the game cycle time stamp is not crossed, the system resets the number of games played in the user database (Step 856) and displays the Play button (Step 857).

If the social game status is locked/closed, from Step 808, and the user does not have enough referrals, measured by the system as the number of friends successfully invited to the system and metered as “referral points”, to open (Step 860), a Locked button is shown (Step 861), indicating that the particular game is locked. If, however, the user does have enough referral points to open the game, the system determines if the game status is locked (Step 862). If it is not locked, the system moves to Step 850, as described above. If it is locked, the system determines if the user has the required number of points (Step 863) and either shows an Unlock and Play button (Step 864) or a Locked button (Step 865). Additionally, each referral may be attributed further value, irrespective of the referral point value.

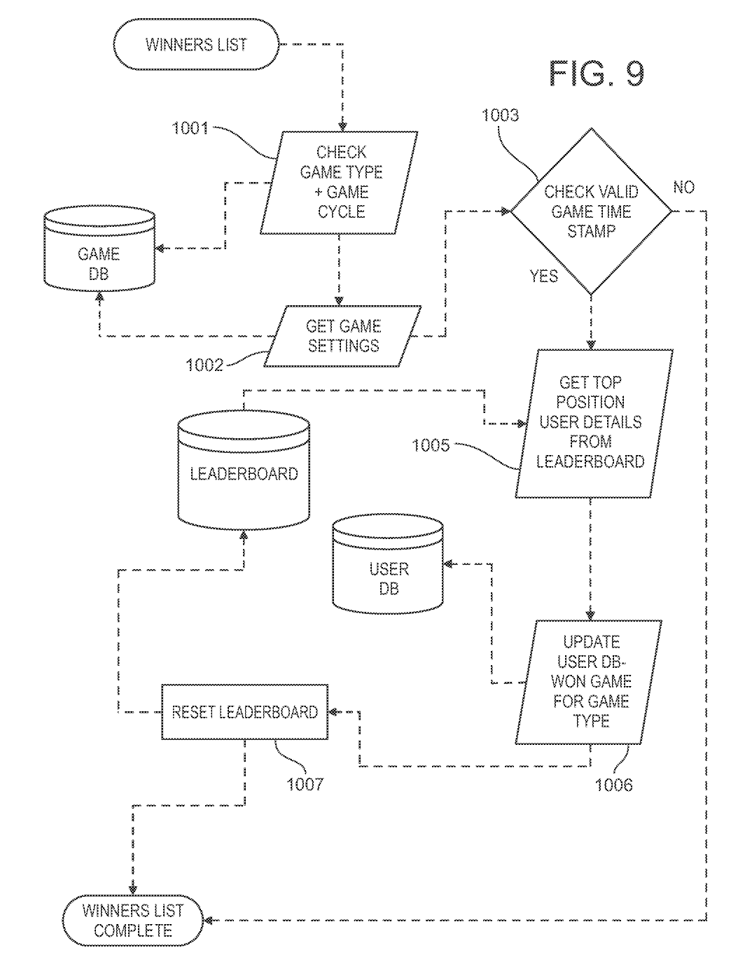

Another part of the system determines the winners, as shown in FIG. 9. The winner can be, e.g., the user with the highest score in the shortest amount of time. First, the game type (prize event) and game cycle (period during which the game is being played) are checked (Step 1001) and the game settings are retrieved (Step 1002), both from the game database. If the game time stamp is invalid (Step 1003), the winners list is considered complete. If valid, the user's details of the top position is pulled from the leaderboard (Step 1005), the user database is updated with the information of the user that won the particular game (Step 1006), and the leaderboard is reset (Step 1007). After Step 1007, the winners list is complete.

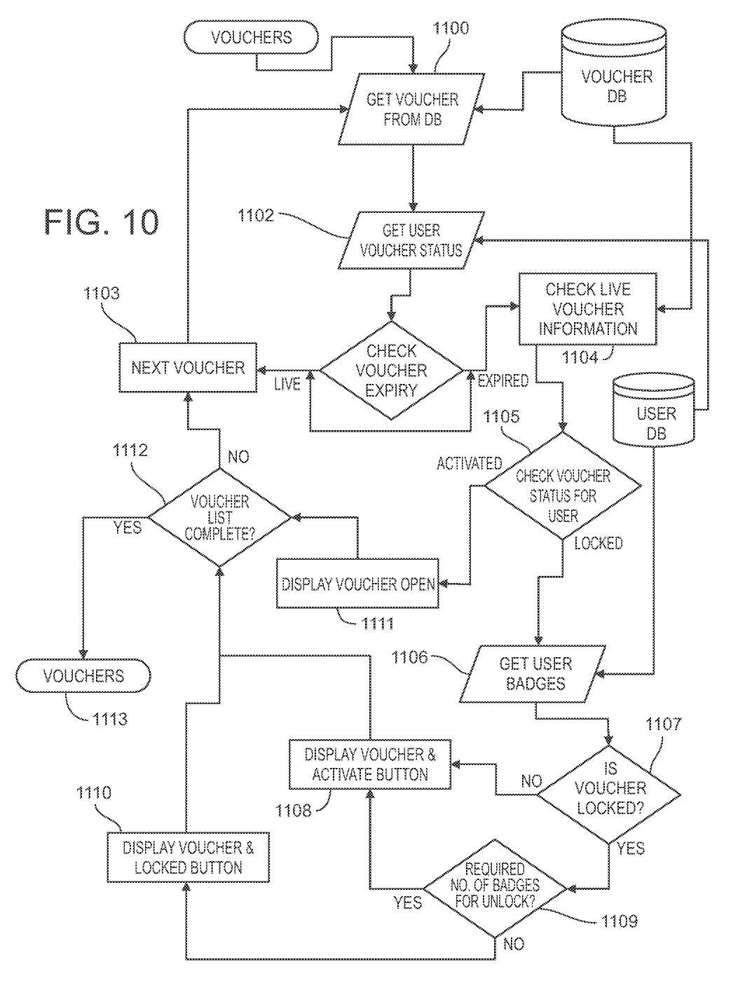

FIG. 10 shows one embodiment of a voucher system which can be used with the invention. In Step 1100, a voucher is obtained from a voucher database The system then determines if the voucher status field is “live” or “expired” (Step 1102). If the voucher is live, the system moves to the next voucher (Step 1103) and proceeds back to Step 1100. If, however, the voucher is expired, the system checks the live voucher information (Step 1104). The system then checks the actual voucher specific information to determine if the particular voucher is locked or activated (Step 1105) for the particular user and voucher. If locked, the user database is polled to determine the number of badges held by the user (Step 1106). If the particular voucher is not locked (Step 1107), a button is provided allowing the user to activate the voucher (Step 1108), by spending a set number of badges. If locked, the system determines if the user has earned enough badges to unlock the voucher (Step 1109), and if so, moves to Step 1108. If the user does not have enough badges, a message is provided informing the user that the voucher is locked (Step 1110). If the voucher status from Step 1105 is activated, the system displays a voucher open screen (Step 111) with a voucher code until the voucher has expired. From Step 1108 and Step 1110, the system check to see if the voucher list is complete (Step 1112), and if not, proceeds back to Step 1103—loading the next voucher. In the event the list is complete, the system determines that the voucher is complete (Step 1113).

The voucher code is effectively a promotion code which can be redeemed by the user. This can be accomplished in any manner as determined by the brand owner, e.g., on a separate website or integrated into the system itself.

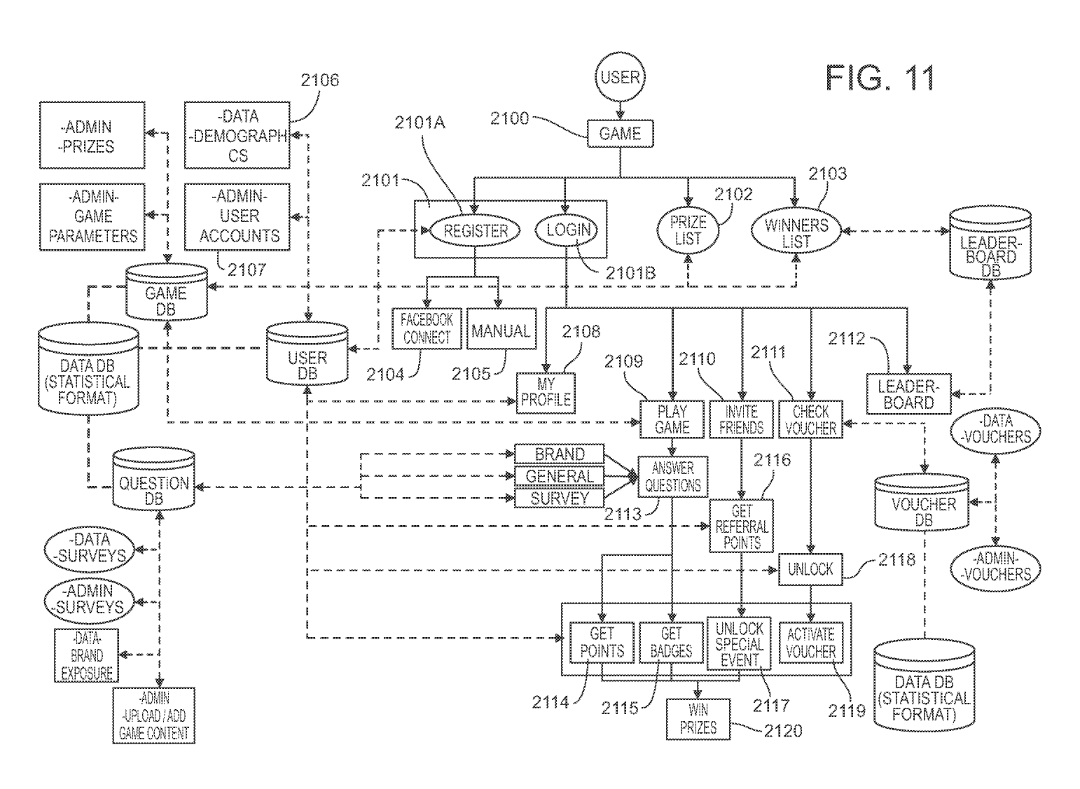

FIG. 11 describes one embodiment of a component the back end of the system, i.e., the part of the system that controls the interaction with the user. Many of these steps can be substantially similar (or even identical to) the steps described with reference to FIGS. 1-10. Initially, the user enters the game (Step 2100) and can login (Step 2101), by registering for his account (Step 2101A) or by entering his login details (Step 2101B), at the same time he can see the prize list (Step 2102) and/or the winners list (Step 2103). In one embodiment, all four different elements are displayed simultaneously by the system, but can also be configured to show only one at a time. If the user elects to register, he can do so through an API from another social network (Step 2104) or manually (Step 2105) by entering his name, email address, etc. Either way, the information is input into the user database where the demographic data is stored (Step 2106), and the user account is created (Step 2107). The data shown from the prize list and winners list are pulled from the Game Database, including the game parameters and prizes, as input by the administrators of the system.

If the user logs in, rather than registering, the system collects profile details and checks this data against the user database (Step 2108). Thereafter, the user can play a game (Step 2109), invite his friends from other social networks (Step 2110), check the voucher list (Step 2111) and/or view the leaderboard (Step 2112). If the user elects to play a game, questions are then pulled from the question database. They can be of general knowledge, or relating directly to the brand and/or contain survey information. The user is then given the opportunity to answer the questions (Step 2113), allowing him to earn points for each correct answer (Step 2114), and, if the game is part of a prize event, additionally earn badges (Step 2115). From Step 2110, the user can be provided with a referral code, allowing invited friends to give the user credit when the code is used, allowing the system to know when to provide the user with referral points (Step 2114).

When one of the user's friends (often from a social network) signs up, the user is provided with referral points (Step 2116). These referral points are separate and distinct from the points (or “general” points) awarded in Step 2114. However, in many embodiments, each referral point is worth a predetermined number of general points, as determined by the system administrator. These referral points can be used to unlock special events (Step 2117). In one embodiment, certain special events can only be unlocked by earning a predetermined number of referral points, thereby providing the user with an incentive to involve his friends in the system. This section of the game system can also be accessed by unlocking a voucher (Step 2118) and unlocking it (Step 2119). The information for the voucher list is provided by a voucher database, which pulls its information from the data database and data relating to the vouchers as input by the administrator. From each of Steps 2114-2117 and 2119, the user can win prizes (Step 2120).

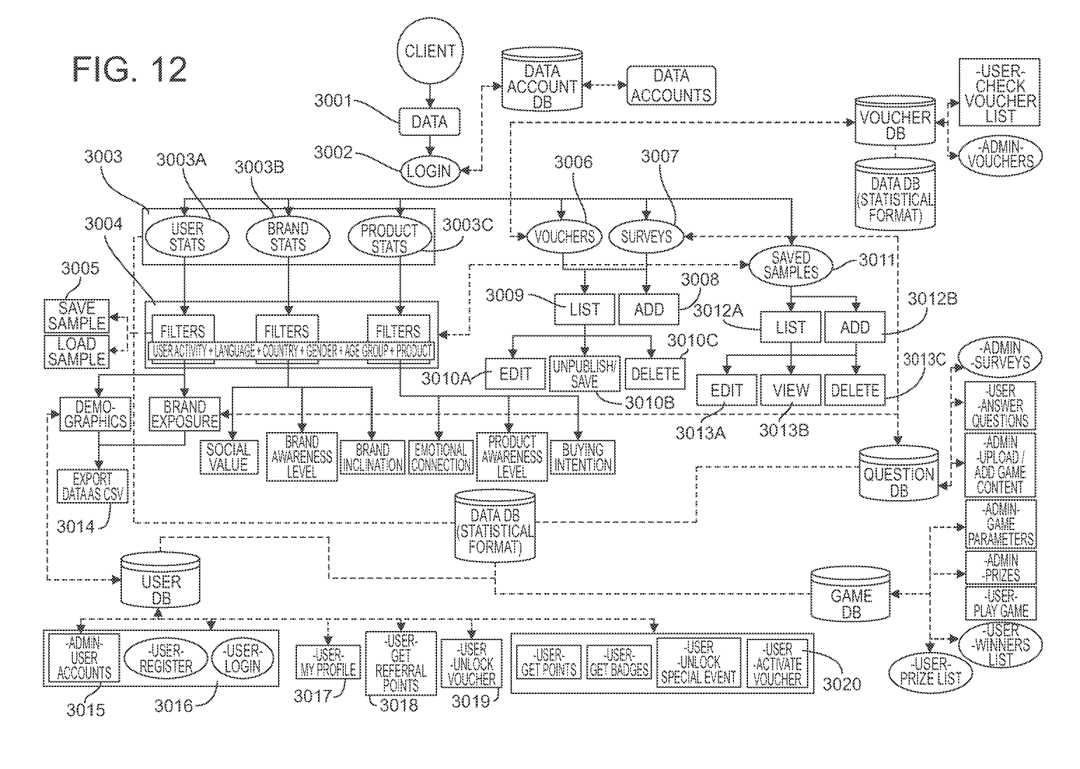

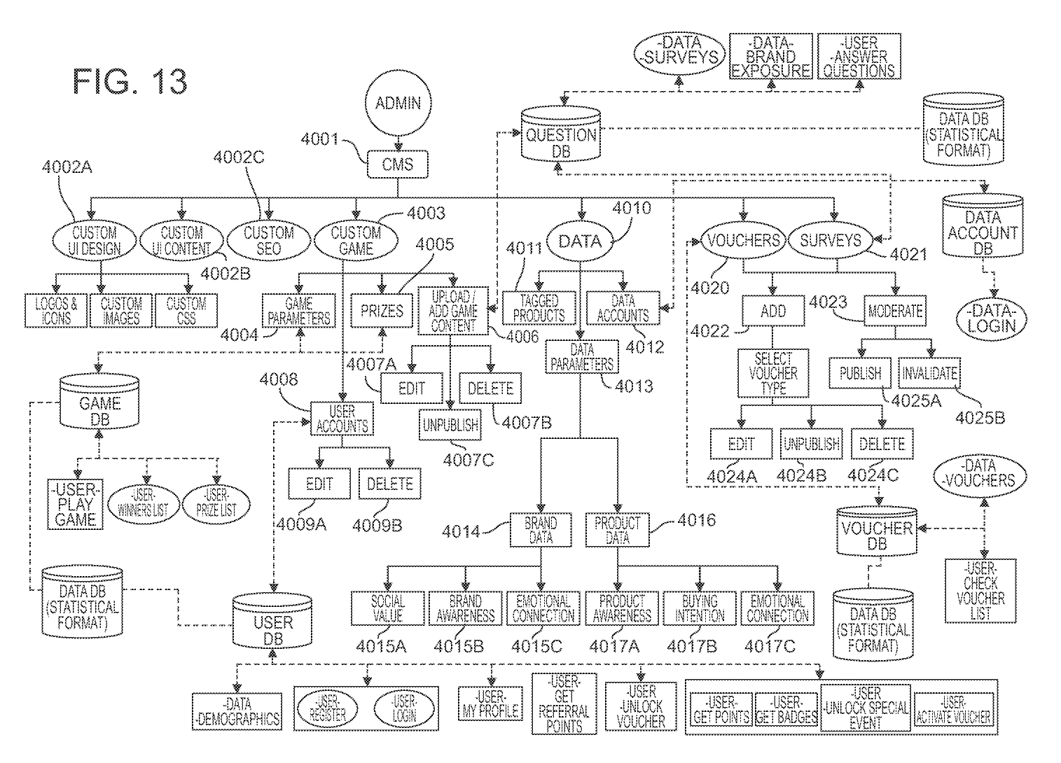

FIG. 12 shows how an administrator of the system can utilize the data collected from the users of the system relating to a particular brand. In a first step, the administrator collects the data in which he is interested (Step 3001) and logs into the system (Step 3002) via the client application. The login data is compared to the information stored in the data account database. The administrator can then review the generic data (Step 3003), or drill down to the components—which can be the user statistics (3003A), brand statistics (3003B) and/or product statistics (3003C). Each of these can be further filtered and/or compared with data relating to user information, such as user activity, nationality, gender, age and product (Step 3004). This filtered information can be saved/loaded into other applications for further analysis (Step 3005).

From the login, the administrator can also manipulate/administer the vouchers and surveys of the system (Steps 3006 and 3007, respectively). From there the administrator can add a voucher or survey (Step 3008) or list one (Step 3009) to be edited (Step 3010A), saved or unpublished (Step 3010B) and/or deleted (Step 3010C). The administrator can also access saved demographic samples linked (or not) to specific products (Step 3011), to list (3012A)—to then be edited (3013A), viewed (3013B) and/or deleted (3013C), or a new sample can be added (Step 3012B). Such samples can be obtained from the Brand and Product Scorecards in the data interface by setting in motion pop-down filters to match the desired demographics of the samples. For example, a brand owner may want to view and analyse the consumer information of English female aged 18-24 only. By setting the nationality, gender and age filters accordingly in the scorecard, the target population of the sample is adjusted to reflect the exact demographic profile. In the event such targeted sample is seen as offering an interesting commercial opportunity, the system offers brand owners the ability to save it and store it for further action of their choice. A sample may also be saved in conjunction with a product in the Product Scorecard. This is designed to allow brand owners who may have identified a commercial match between a target demographic sample and a specific product, to upload a corresponding voucher using a pre-saved profile of players to send it to.

The filtered data from Step 3004 can be further analyzed to determine any number of measurable components. In one embodiment, specific questions used during the registering step, training mode and prize mode are particularly designed to elicit responses providing the system with data relating to a wide range of useful statistical elements. Suitable elements include demographics, brand exposure, social value, brand awareness level, brand inclination, emotional connection product awareness level and buying intention. Some or all of the elements can be exported out of the system in proprietary or non-proprietary formats, e.g., CSV or Excel, to be further analyzed (Step 3014).

From the user database, the administrator can access administrator accounts (Step 3015), and user registration information (Step 3016), as well as other user information, including profile (3017), referral points (3018) and voucher lock status (3019). The administrator can also view and edit data referring to points, badges, lock status of special events and voucher activation status (Step 3020).

In FIG. 14, one embodiment of the content management system (CMS) is shown. Once the administrator logs into the CMS (Step 4001), he can access the user interface sections (Steps 4002A, 4002B and 4002C), which include the ability to modify the structure of the user interface, including the displayed logos and icons, the images as well as the cascading style sheets (CSS), and the particular tags and meta-tags used in search engine optimization (SEO). He is also presented with the ability to customize the particulars of the game (Step 4003), including the game parameters (Step 4004) and prizes (Step 4005)—both with information from the game database. From Step 4003, the administrator can also upload or add game content (Step 4006) which includes the ability to edit, delete and/or unpublish game content (Steps 400A-C, respectively). He can also modify the user accounts (Step 4008), by, e.g., editing or deleting any user account (4009A and 4009B, respectively).

The CMS also gives the administrator the ability to create, edit and manage all settings used to collect data from users (Step 4010), including information relating to Tagged Products (Step 4011) and data access accounts (Step 4012). Tagged Products are the official product being listed by brand owners for the purpose of gathering data on them. Such products are ‘tagged’ or associated with the relevant branded content shown to users of the system. Data accounts are created by the Super Administrator (the owner of the system) in order to provide brand partners access to their data only. Each brand partner has its own restricted-view data account. Step 4010 allows the administrator/brand owner to set the data parameters of their choice (Step 4013), starting with brand data (4014) made of a social value score, brand awareness score and brand emotional connection score (Steps 4015A-C, respectively), and product data (4016), made of a product awareness score, product buy intentions score and product emotional connection score (Steps 4017A-C, respectively).

The CMS can also be configured to give the administrator access to the vouchers (4020) and surveys (4021). From here, a new voucher/survey can be added (Step 4022) or moderated (Step 4023), and depending on the type, edited, unpublished or deleted (Steps 4024A-C, respectively). The moderated vouchers/surveys can be published and/or invalidated (Steps 4025A and B, respectively), depending whether the Super Administrator accepts and publishes the format of such vouchers/surveys or returns it to the brand owner as invalid for publication.

Moreover, the apparatuses and methods of the disclosure can be implemented in hardware, firmware or as software or computer code that is stored on a non-transitory machine readable medium such as a CD ROM, a RAM, a floppy disk, a hard disk, or a magneto-optical disk or computer code downloaded over a network originally stored on a remote recording medium or a non-transitory machine readable medium and stored on a local non-transitory recording medium, so that the methods described herein are loaded into hardware such as a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor” or “microprocessor” constitute hardware in the claimed invention. Under the broadest reasonable interpretation, the appended claims constitute statutory subject matter in compliance with 35 U.S.C. §101 and none of the elements consist of software per se.

As referred to herein, the term “computing device” should be broadly construed. It can include any type of mobile device, for example, a smart phone, a cell phone, a pager, a personal digital assistant (PDA, e.g., with GPRS NIC), a mobile computer with a smart phone client, or the like. A computing device can also include any type of conventional computer, for example, a desktop computer or a laptop computer. A typical mobile device is a wireless data access-enabled device (e.g., an iPHONE® smart phone, a BLACKBERRY® smart phone, a NEXUS ONE™ smart phone, an iPAD™ device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on a mobile device, the examples may similarly be implemented on any suitable computing device.

As referred to herein, an “interface” or “user interface” is generally a system by which users interact with a computing device. An interface can include an input for allowing users to manipulate a computing device, and can include an output for allowing the system to present information and/or data, indicate the effects of the user's manipulation, etc. An example of an interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. The display object can be displayed on a display screen of a mobile device and can be selected by and interacted with by a user using the interface. In an example, the display of the mobile device can be a touch screen, which can display the display icon. The user can depress the area of the display screen at which the display icon is displayed for selecting the display icon. In another example, the user can use any other suitable interface of a mobile device, such as a keypad, to select the display icon or display object. For example, the user can use a track ball or arrow keys for moving a cursor to highlight and select the display object.

Operating environments in which embodiments of the presently disclosed subject matter may be implemented are also well-known. In a representative embodiment, a computing device, such as a mobile device, is connectable (for example, via WAP) to a transmission functionality that varies depending on implementation. Thus, for example, where the operating environment is a wide area wireless network (e.g., a 2.5G network, a 3G network, or any 4G network), the transmission functionality comprises one or more components such as a mobile switching center (MSC) (an enhanced ISDN switch that is responsible for call handling of mobile subscribers), a visitor location register (VLR) (an intelligent database that stores on a temporary basis data required to handle calls set up or received by mobile devices registered with the VLR), a home location register (HLR) (an intelligent database responsible for management of each subscriber's records), one or more base stations (which provide radio coverage with a cell), a base station controller (BSC) (a switch that acts as a local concentrator of traffic and provides local switching to effect handover between base stations), and a packet control unit (PCU) (a device that separates data traffic coming from a mobile device). The HLR also controls certain services associated with incoming calls. Of course, the presently disclosed subject matter may be implemented in other and next-generation mobile networks and devices as well. The mobile device is the physical equipment used by the end user, typically a subscriber to the wireless network. Typically, a mobile device is a 2.5G-compliant device or 3G-compliant device (or a 4G-compliant device) that includes a subscriber identity module (SIM), which is a smart card that carries subscriber-specific information, mobile equipment (e.g., radio and associated signal processing devices), a user interface (or a man-machine interface (MMI), and one or more interfaces to external devices (e.g., computers, PDAs, and the like). The mobile device may also include a memory or data store.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method for gamifying user engagement and e-commerce with at least one brand, the method comprising:
using at least a processor and a memory for:
registering a user with a system;
presenting branded content to the user via a computing device;
collecting responses to the branded content from the computing device;
providing the user with a reward for responses; and
disclosing the responses to an administrator.

2. The method of claim 1, wherein the registering comprises obtaining demographic data from the computing device of the user.

3. The method of claim 2, wherein the obtaining demographic data comprises accumulating at least one selected from the group consisting of name, physical address, e-mail address, telephone number, sex, age, national origin, birth date, marital status, income, occupation, and education level.

4. The method of claim 2, wherein the disclosing comprises analyzing the responses along with the demographic data.

5. The method of claim 1, wherein the presenting comprises displaying content, which content is permanent or temporary.

6. The method of claim 1, wherein the presenting comprises displaying content, which content is at least one selected from the group consisting of text, picture and video.

7. The method of claim 1, wherein the branded content comprises at least one question selected from the group consisting of factual content, brand awareness, buying tendencies, soft questions and surveys.

8. The method of claim 1, wherein the reward is a physical object or service.

9. The method of claim 1, wherein the reward is at least one point.

10. The method of claim 9, further comprising allowing access to regular prize events, based on the number of points had by the user.

11. The method of claim 10, further comprising giving the user badges for taking part in regular prize events.

12. The method of claim 11, further comprising granting access to vouchers, depending upon the number of badges had by the user, wherein the voucher is redeemable by the user

13. The method of claim 12, wherein the voucher is valid for a discount on the purchase of a physical object or service.

14. The method of claim 9, wherein the number of points rewarded is determined based on the collected responses.

15. The method of claim 1, wherein the reward is a voucher redeemable by the user for a discount on the purchase of a physical object.

16. The method of claim 1, further comprising allowing the user to invite friends to register through a social network.

17. The method of claim 16, wherein the allowing comprises providing the user with a code to be used by the friends and granting rewards to the user each time the code is used.

18. The method of claim 17, wherein the granting comprises providing the user with referral points.

19. The method of claim 18, wherein the presenting of branded content comprises selecting the content to be presented based on the number of referral points had by the user.

20. The method of claim 1, wherein:
the presenting comprises showing content of a first brand to a first user and showing content of a second brand to a second user; and
the disclosing comprises showing the collected responses relating to the first brand to a first administrator and showing the collected responses relating to the second brand to a second administrator.

21. The method of claim 1, further comprising performing an analysis of the responses and sending at least one of vouchers and surveys to one or more users based on the analysis.

22. A system for gamifying a user's engagement and e-commerce with at least one brand, the system comprising:
at least a processor and memory configured to:
register a user with a system;
present branded content to the user via a computing device;
collect responses to the branded content from the computing device;
provide the user with a reward for responses; and
present the responses to an administrator.

23. The system of claim 22, wherein the at least a processor and memory are configured to obtain demographic data from the user via one or more computing devices.

24. The system of claim 23, wherein the obtaining demographic data comprises accumulating at least one selected from the group consisting of name, physical address, e-mail address, telephone number, age, sex, national origin, birth date, marital status, income, occupation, and education level.

25. The system of claim 23, wherein the at least a processor and memory is configured to analyze the responses along with the demographic data as part of the presenting.

26. The system of claim 22, wherein at least a processor and memory is configured to display content as part of the presenting, which content is permanent or temporary.

27. The system of claim 22, wherein at least a processor and memory is configured to display content, which content is at least one selected from the group consisting of text, picture and video.

28. The system of claim 22, wherein the branded content comprises at least one question selected from the group consisting of factual content, brand awareness, buying tendencies, soft questions and surveys.

29. The system of claim 22, wherein the reward is a physical object or service.

30. The system of claim 22, wherein the reward is at least one point.

31. The system of claim 30, wherein at least a processor and memory is configured to allow access to regular prize events, based on the number of points had by the user.

32. The system of claim 31, wherein at least a processor and memory is configured to give the user badges taking part in regular prize events.

33. The system of claim 32, wherein at least a processor and memory is configured to grant access to vouchers, depending upon the number of badges had by the user, wherein the voucher is redeemable by the user.

34. The system of claim 32, wherein the voucher is valid for a discount on the purchase of physical object or service.

35. The system of claim 33, wherein the specified branded content is determined based on the collected responses.

36. The system of claim 31, wherein the reward is a voucher redeemable by the user for a discount on the purchase of a physical object.

37. The system of claim 22, wherein at least a processor and memory is configured to allow the user to invite friends to register through a social network.

38. The system of claim 37, wherein at least a processor and memory is further configured to provide the user with a code to be used by the friends and granting rewards to the user each time the code is used.

39. The system of claim 38, wherein the at least a processor and memory is configured to provide the user with referral points.

40. The system of claim 39, wherein the at least a processor and memory is configured to select the content to be presented from the branded content based on the number of referral points had by the user.

41. The system of claim 22, wherein the at least a processor and memory is configured to:
display content of a first brand to a first user and showing content of a second brand to a second user; and
show the collected responses relating to the first brand to a first administrator and showing the collected responses relating to the second brand to a second administrator.
